(19) United States
(12) Patent Application Publication
(10) Pub. No.: US 2009/0107179 A1
(43) Pub. Date: Apr. 30, 2009

(54) GLASS PASSAGE AND METHOD OF MANUFACTURING MOLDED PRODUCT OF OPTICAL GLASS USING THE PASSAGE

(75) Inventors: Ryousuke SAKAI, Sagamihara (JP); Atsushi NAGAOKA, Sagamihara (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OHARA INC., Sagamihara (JP)

(21) Appl. No.: 12/256,209

(22) Filed: Oct. 22, 2008

(30) Foreign Application Priority Data
Oct. 24, 2007 (JP) 2007-276179

(51) Int. Cl. C03B 17/00; C03B 7/14

(52) U.S. Cl. 65/66; 65/164

(57) ABSTRACT

The present invention is that, in a glass passage where it is usual that the flow rate near the center tends to become high, stirring effect for the glass flow is enhanced whereby temperature distribution is made uniform and generation of stria and devitrification is reduced. As a result, there is provided a passage by which glass blocks of highly refractive glass or low-Tg glass in recent years where selection of molding conditions is very difficult are able to be obtained easily and in high quality. Another object is to provide a passage by which simple control in a short distance is made possible whereby miniaturization of the device is possible even in the conventional glass. A passage which is connected to a melted glass vessel and flows out the melted glass which is characterized in that, in the inner wall, the above-mentioned passage has a control board for controlling the flow of the melted glass. The passage according to the above, wherein the control board is installed in the inner wall of the passage in an angle against the progress of the glass flow.

### BACKGROUND OF THE INVENTION

1. Field of the Invention

The present invention relates to an art for the manufacture of a molded product of optical glass.

2. Description of the Related Art

Recently, in the field of optical instruments such as digital cameras and projectors, there has been a request for miniaturization and weight reduction and, as a result, there has been an increasing demand for aspheric lenses by which numbers of the constituting lenses are able to be reduced.

Usually, in lenses constituting an optical system, there are spherical lens and aspheric lens. Many spherical lenses are manufactured by cutting and abrading of a molded glass product prepared by a reheat press molding of glass materials. On the other hand, in the case of aspheric lens, a method where a heated and softened preform is subjected to a press molding using a metal mold having a highly precisely molded surface and a shape of the highly precisely molded surface of the metal mold is transcribed to a preform material or, in other words, manufacture by means of a precise press molding has been a mainstream.

As to the preform for the precise press molding, there are many cases where spherical, elliptic or flat molded product of glass (glass gob) is used and it is able to be manufactured in such a manner that material glass is melted in a melting device such as crucible, flown out onto a mold from a nozzle or the like connected to the melting device and the resulting plate-shaped or rod-shaped glass is further subjected to a cold rolling.

In recent years, there has been used an art where the melted glass flown out from the passage such as a nozzle is cut by a shear or separated by means of surface tension, flown down (dropped down) onto a porous mold wherefrom gas, for example, is spouted to float and mold and made into glass gob in appropriate size and shape. However, since traces by cutting with a shear may remain on the glass gob in the former method, it is often in recent years to use the latter method.

In any of the above methods, various shapes of nozzle have been invented for controlling the temperature and the flowing-out amount of the glass stream or for preventing the generation of defect such as stria and devitrification upon molding in flowing out the glass from the passage. In recent years, although there have been proposed many means dealing with the tendency that liquid phase temperature of optical glass becomes high and/or viscosity thereof becomes low or that viscosity becomes low as a result of lowering in Tg, it is the current status that no sufficient countermeasure has been achieved yet.

In Patent Document 1, there is a description for a nozzle where diameter of the outflow opening is made larger than the diameter of the passage or, for example, outflow opening for melted glass at the end of the passage is opened in a taper form whereby the melted glass flow is made to retain for long time by the outflow opening of the passage and a flowing-down timing of the glass is controlled to be slow.

In Patent Document 2, there is a description for a method where, when the melted glass starts in flow from the melting device, passes through a pipe and is flown out from the outflow opening, the inside is made narrow to make the flow rate distribution uniform and to suppress the retention of the denatured glass wherefrom the components are evaporated so that generation of stria is prevented. It is also described that, in order to prevent a decrease in flow rate by making the inside narrow, temperature of the narrowed area is controlled to higher than the area other than the narrowed area.

In Patent Document 3, there is mentioned a method where a resistant material is installed in the inner part of the passage to reduce the flow rate of the glass flow running the center of the cross section of the passage so that the maximum weight of the obtainable glass gob is increased.

Patent Document 1: Gazette of Japanese Patent Laid-Open No. 10/036,123

Patent Document 2: Gazette of Japanese Patent Laid-Open No. 2003/306,334

Patent Document 3: Gazette of Japanese Patent Laid-Open No. 08/026,737

However, the above-mentioned conventional methods have the following problems.

When melted glass is flown out from a melting vessel via a passage and molded in a mold, it is generally necessary that a temperature control where the temperature from the melting vessel to the outflow opening is gradually lowered so that temperature of the melted glass is lowered down to the temperature suitable for molding. At that time, stria due to evaporation of glass components may be generated, for example, after being flown out and, in that case, it should be dealt with by lowering the temperature controlling the passage. However, the melted glass flow is nothing but a highly viscous fluid and the temperature in the nozzle is low near the inner wall and is high near the center of gravity of the cross section. In addition, flow rate distribution is low near the inner wall and is high near the center of gravity of the cross section.

When the temperature of the glass flow is controlled by measuring the temperature of the passage, although the measured temperature at the passage reflects the glass temperature near the inner wall surface nearly correctly, it shows low temperature which is apart from the temperature of the center of the glass flow (i.e., the temperature of the glass flow passing through near the center of gravity of the cross section of the passage in the passage). Therefore, in the glass where the liquid phase temperature is high, the passage temperature (glass temperature near the inner wall of the passage) lowers down to the temperature for growing the crystals or, the so-called devitrifying temperature, before lowering to the temperature where no evaporation of the center of the glass flow takes place whereby generation of devitrification may be resulted.

In the passage mentioned in Patent Document 1, since the outflow opening opens in a taper shape and the inner diameter becomes large, differences in temperature and in flow rate between the inner wall surface and the glass flow center increase whereby the above-mentioned tendency becomes much more significant.

When the passage which is able to be narrowed as in Patent Document 2 is used, although there is an effect of making the flow rate distribution of glass flow uniform, that results in taking out the glass flow of high temperature near the center of gravity of cross section of the passage whereby it is difficult to prevent the stria derived from evaporation upon flowing out. When the control temperature is lowered for suppressing the evaporation, generation and growth of devitrification are apt to happen immediately and, as a result, the passage of the narrowed area is clogged and the outflow itself is apt to stop. In the Examples, the temperature of the narrowed area is made higher than the area which is other than the narrowed area for suppressing the lowering in flow rate due to narrowing and it is apparent that said method is not suitable for the manufacture of highly refractive glass in recent years.

In the passage mentioned in Patent Document 3, although flowing-down speed of the melted glass in the central area is retarded by a resistant material installed in the center of the inside and speed distribution of the flowing speed is made uniform, the temperature soon becomes the central temperature of the high-temperature glass by the use of a resistant material mainly comprising noble metals having small heat capacity. Therefore, an effect of lowering the temperature of the center of glass flow is not achieved and there is no suppressive effect for stria due to evaporation. It is also necessary that, as in FIG. 3 of Patent Document 3, resisting material is fixed using a supporting material and it is quite difficult to process into a glass outflow passage which mainly comprises noble metal such as platinum. Further, although claim 4 of Patent Document 3 is characterized in that plural passages are installed in the bottom of a crucible and front end of each of the plural passages is connected each other whereby one passage opening is constituted, glass flow of high temperature is generated in the center of each of the plural passages and no effect for lowering the central temperature of flowing-down glass flow is achieved. When such complicated structures are applied, changes in the structure for adapting glass temperature, viscosity, wetting, density and liquid pressure are very difficult whereby flow rate and temperature distribution also become complicated and there has been a demand for simpler structure in view of such a respect as well.

### SUMMARY OF THE INVENTION

The present invention is that, in a glass passage where it is usual that the flow rate near the center tends to become high, stirring effect for the glass flow is enhanced whereby temperature distribution is made uniform and generation of stria and devitrification is reduced. As a result, there is provided a passage by which glass blocks of highly refractive glass or low-Tg glass in recent years where selection of molding conditions is very difficult are able to be obtained easily and in high quality. Another object is to provide a passage by which simple control in a short distance is made possible whereby miniaturization of the device is possible even in the conventional glass.

The present inventors have found that, when a control board is installed in the inner wall of the passage, stirring effect of glass flow is able to be enhanced and temperature and flow rate distributions are able to be made uniform and, further, desired temperature and flow rate distribution are able to be achieved whereby disadvantages such as stria are able to be suppressed and, as a result, they have solved the above problems.

The first constitution of the present invention is a passage which is connected to a melted glass vessel and flows out the melted glass which is characterized in that, in the inner wall, the above-mentioned passage has a control board for controlling the flow of the melted glass.

The second constitution of the present invention is the passage according to the above first constitution, wherein the control board is installed in the inner wall of the passage in an angle against the progress of the glass flow.

The third constitution of the present invention is the passage according to the above second constitution, wherein there is included an area where the angle between a direction from the contacting part of the passage inner wall and the control board in the above control board to the center of the passage and a direction against the progressing direction of the glass flow in the passage is less than 90°.

The fourth constitution of the present invention is the passage according to any of the above first to the third constitutions, wherein the control board is installed in plurals.

The fifth constitution of the present invention is a method for the manufacture of a molded product of glass including the steps where the glass material is melted in a melting vessel and the melted glass is flown out to a mold via a nozzle connected to the melting vessel so as to mold a glass molded product which is characterized in that the melted glass is passed through any of the passages mentioned in the above first to the fourth constitutions.

The sixth constitution of the present invention is the method according to the above fifth constitution, wherein, by passing through any of the passages of the above first to the fourth constitutions, temperature and speed of the glass flow in the passage are adjusted.

### BRIEF DESCRIPTION OF THE DRAWINGS

FIG. 1 is an entire drawing of the passage of the present invention.

FIG. 2 is a longitudinal cross-sectional view of the passage of the present invention.

FIG. 3 is an upper side drawing of the passage of the present invention.

### DETAILED DESCRIPTION OF PREFERRED EMBODIMENTS

As hereunder, the passage of the present invention will be illustrated in detail although the present invention is never limited to the following embodiments but it is able to be carried out with appropriate modifications within a scope of the objects of the present invention.

In the present invention, “passage” is a concept including the whole passage where glass flow passes as well as an outflow opening which is connected to a melting vessel which melts and/or holds the melted glass and the melted glass is flown out to a mold (such as a molding mold). In other words, it is a concept including the so-called pipe, orifice and nozzle.

Usually, temperature control of the passage is carried out by various methods and temperature distribution of melted glass flowing the passage is highest near the center of gravity of the cross section of the passage (when the cross section of the passage is nearly circular, its center) whereby flow rate is also high in that area. As mentioned already, gutter is installed in the inner wall of the passage in the present invention whereby a flowing direction of the glass flow is locally changed and, as a result, glass flow is mixed each other and it is intended to mitigate the gap in temperature distribution and flow rate distribution.

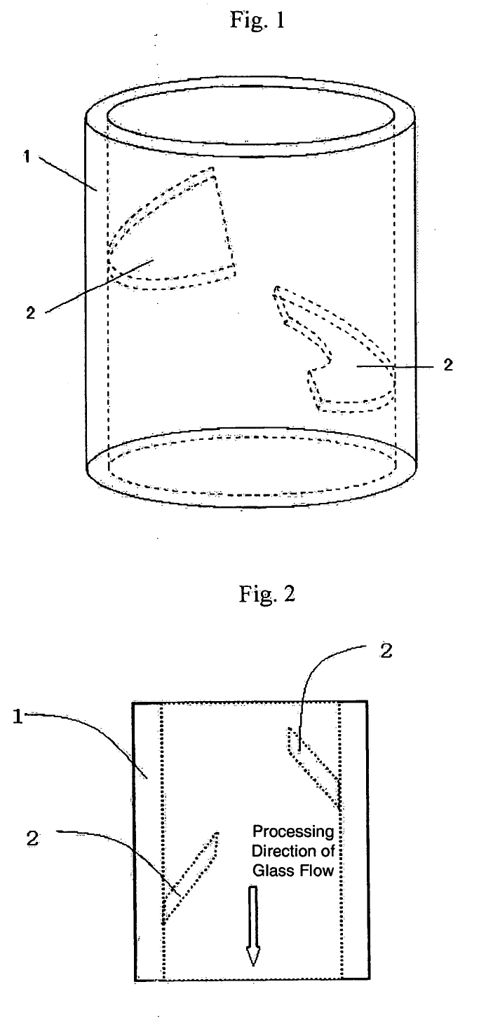

FIG. 1 is an example of the passage of the present invention. As shown in FIG. 1, a control board 2 is installed in the inner wall of the passage 1 and there is no particular limitation for the method of the installation thereof. It is most simple and convenient to install in the inner wall by means of welding.

There is no particular limitation for the shape of the control board 2 but any of flat or curved ones may be acceptable. In the present invention, the shape of the control board 2 has a function of changing the flow or the glass flow to determine the flow in various modes. When such a flow is formed, heat exchange among the glass flows is activated and temperature distribution is made nearer uniform whereby stria and devitrification of the flown-out glass are able to be reduced. In view of making the temperature distribution of glass flow uniform, spiral form maybe also acceptable and it is preferred that plural control boards 2 are aligned where shape and direction thereof are discontinuous and irregular. In that case, shape and direction of each control board may be either uniform or irregular.

In order to enhance the stirring efficiency of glass flow and to promote for making the temperature uniform, the control board 2 is preferred to be installed in the passage inner wall in an angle which is against the progress of the glass flow. The expression that it is installed in an angle against the progress of the glass flow means that the control board 2 is installed in inclining to the upstream side from vertical direction to the flowing-out direction of the glass. To be more specific, it is preferred that, on the above control board 2, there is included the area where the angle between the direction to the passage center from the contacting part of the control board to the passage inner wall and the direction against the progress of the glass flow on the passage is less than 90°.

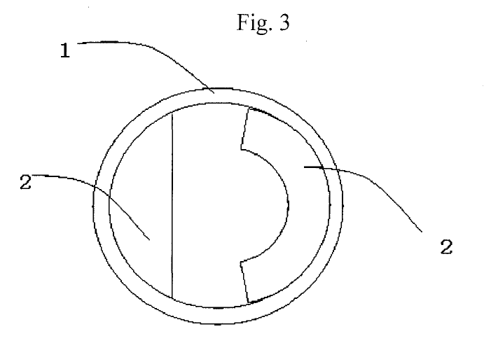

FIG. 2 is a longitudinal cross-sectional view of the passage of the present invention. As such, the control board 2 used for the passage of the present invention is installed inclining to the direction against the flowing direction of the glass. FIG. 3 is an upper surface drawing of the passage of the present invention. As such, the control board 2 used in the passage of the present invention shields a part of the glass passage whereby it has a stirring effect to the glass flow.

Further, the stirring effect of the melted glass flow is greatly affected by the relation between the passage diameter and the area of the control board 2. When the area of the control board is too small, the stirring effect becomes small and it is hard to make the temperature in the passage uniform while, when the area is too big, progress of the glass flow is disturbed and it is rather hard to give glass block of good quality. Accordingly, the area of the control board 2 is preferably not less than 2%, more preferably not less than 5% and, most preferably, not less than 7% of the cross section of the passage and is preferably not more than 80%, more preferably not more than 70% and, most preferably, not more than 60% thereof.

Although there is no particular limitation for the position where the control board is installed, the position is determined by considering glass thermal conductivity, heat capacity, passage diameter, flow rate, desired temperature/temperature distribution, etc. into consideration. Although it is of course dependent upon the full length of the passage 1, when it is too upstream, new temperature distribution is apt to be formed as the flow proceeds even if the temperature is once made uniform due to the stirring effect caused by the groove and, as a result, the effect expected in the present invention is hardly available. Accordingly, the above groove is available within a range of up to 50%, more preferably up to 45% and, most preferably, up to 40% to the full length of the passage. If necessary, it may be installed near the lowermost terminal of the passage (i.e., outflow opening of the passage).

The passage 1 of the present invention does not disturb the heating and/or the cooling by the passage 1 itself and/or by additional means from outside. As to the heating means of the passage 1 itself, a known heating method by a direct application of electricity to the passage may be used while, as to the additional means from outside, known means such as gas burner, electric heater, infrared ray irradiation and high-frequency wave heating may be appropriately used. Moreover, poor outcome such as devitrification and stria is able to be further suppressed when the area near the outflow opening of the glass flow is covered and heated using a ring burner or the like.

There is no particular limitation for the molding means of the glass using the passage of the present invention. In molding the optical glass, it may be continuously flown out to the mold as a glass flow and subjected to a continuous molding into glass in a form of plate, rod, etc. or it may be subjected to shear or surface tension to separate glass gob and then subjected to a flowing molding on a porous mold so that glass gob is molded.

As to the material for the passage 1 of the present invention, a material used for melting step of glass may be usually used and, for example, platinum, reinforced platinum, gold, reinforced gold, rhodium, noble metal and alloy thereof or quartz may be used. It is also possible to use a material which is metal-plated by known means such as platinum where its inside is plated with gold or coated with ceramic such as SiC.

In the present invention, inner structure of the passage 1 is stipulated and, therefore, the atmosphere near the outflow opening of the passage may be appropriately modified. For example, it may be an inert gas atmosphere such as atmosphere of nitrogen or argon. In some cases, the outflow opening of the passage may be covered by heated atmosphere.

### EXAMPLES

As hereunder, specific examples of the present invention will be illustrated.

### Example 1

In this Example, optical glass was melted using a platinum crucible, the melted glass was flown out from the outflow opening at the end thereof via a passage connected to the crucible and subjected to a floatation molding on an amorphous mold made of tungsten carbide wherefrom gas was blown out to prepare glass gob for use as a preform for a precise press molding.

As to the passage, a reinforced platinum passage in the same shape as in the above FIG. 1 was used. Inner diameter of the passage was expanded to 3 mm (cross section: 7.07 mm²) and outflow opening was expanded to 6 mm. Full length of the passage or the length from the exit of the crucible to the outflow opening at the end of the passage was 2 m. Thickness of the passage wall was 3 mm.

A control board in the passage was installed at the point between the end of the outflow opening and 500 mm therefrom. Cross section of the control board was 3.00 mm². 2 is that which was installed in the inner wall by means of welding and its thickness was 1 mm. The control board was on the plate and its angle to the passage inner wall was 30°.

A receiving mold was prepared from amorphous stainless steel and, when the melted glass was received under the state where air is blown out from the receiving surface, the melted glass is received in a state of being floated from the receiving mold to give glass gob.

As to the glass used, optical glass mainly comprising boron oxide and lanthanum oxide was melted. The crucible was kept at about 1,200° C. and the outflow pipe was kept at about 1,100° C. by electrical heating. The melted glass from the outflow opening was made into a state where it was separated into liquid droplets. The outflow amount of the melted glass at that time was 80 g per minute.

When the glass gob was observed by naked eye for the optical defects such as devitrification and stria, no such defect was found but it was glass gob of a high quality which is able to be used as a preform for molding an optical element.

What is claimed is:

1. A passage which is connected to a melted glass vessel and flows out the melted glass which is characterized in that, in the inner wall, the above-mentioned passage has a control board for controlling the flow of the melted glass.

2. The passage according to claim 1 wherein the control board is installed in the inner wall of the passage in an angle against the progress of the glass flow.

3. The passage according to claim 1 wherein there is included an area where the angle between a direction from the contacting part of the passage inner wall and the control board in the above control board to the center of the passage and a direction against the progressing direction of the glass flow in the passage is less than 90°.

4. The passage according to claim 1 wherein the control board is installed in plurals.

5. A method for the manufacture of a molded product of glass including the steps where the glass material is melted in a melting vessel and the melted glass is flown out to a mold via a nozzle connected to the melting vessel so as to mold a glass molded product which is characterized in that the melted glass is passed through any of the passages mentioned in the above first to the fourth constitutions.

6. The method according to claim 5 wherein, by passing through any of the passages of the above first to the fourth constitutions, temperature and speed of the glass flow in the passage are adjusted.
